(19) United States
(12) Patent Application Publication
(10) Pub. No.: US 2007/0190828 A1
(43) Pub. Date: Aug. 16, 2007

(54) METHOD FOR SUBSTANTIALLY PREVENTING CONTAMINATION OF ELECTRICAL CONTACTS

(75) Inventors: Jeffrey A. Goldman, Acton, MA (US); Daniel E. Sullivan, Cambridge, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc., Hercules, CA (US)

(21) Appl. No.: 11/671,195

(22) Filed: Feb. 5, 2007

Related U.S. Application Data
(60) Provisional application No. 60/772,511, filed on Feb. 10, 2006.

(51) Int. Cl. H01R 13/44

(52) U.S. Cl. 439/135

(57) ABSTRACT

A method to substantially eliminate carry-over contamination due to electrical contacts in a device, wherein the electrical contacts are in contact with one or more macromolecules during a procedure and wherein an amount of said one or more macromolecules remains on said electrical contacts after contact is completed, the method comprising heating said electrical contacts and/or said amount of one or more macromolecules remaining on said electrical contacts such that said one or more macromolecules remaining thereon are rendered substantially unable to interact with macromolecules of subsequent procedures and are rendered substantially unable to adversely participate in reactions of subsequent procedures in which said electrical contacts later are used.

### BACKGROUND OF THE INVENTION

This invention relates to methods for cleaning or substantially preventing “carry-over” contamination due to electrical contacts by various types of macromolecules, and particularly to such methods for reducing carry-over contamination due to electrical contacts in an apparatus used to carry out an assay or other process for which results are dependent on specific macromolecular interactions such as nucleic acid hybridization. Examples would include a chip or other device for carrying out a polymerase chain reaction (PCR) assay, microarray assay, or other operations for which results are dependent on nucleic acid hybridization and in which electrodes or electrical contacts are inserted into a vessel containing a sample, such as electrophoresis, electroporation or high-throughput electroporation. Electrical contacts may be used in various ways and stages in such processes, for example, in sample preparation, sample purification, fluid locomotion, electroporation, electrophoresis, fluid heating, resistance and/or electromagnetic sensing, magnetic field generation, valve operation, etc. The apparatus involved may be part of a chip that also will be used in carrying out a PCR assay, or it may be a stand-alone apparatus or chip that processes samples on which such an assay will be carried out later. In any case, the invention is not limited to electrical contacts used in or in connection with PCR assays, but is applicable to electrical contacts used in any process or operation and in which said contacts may become contaminated with nucleic acids or other macromolecules such that the contacts cannot be reused for a subsequent same or different procedure without the potential of “carry-over” contamination.

In carrying out certain processes such as PCR and other assays in devices to which the present invention relates, a vessel, e.g., a multi-well plate or a microfluidic device such as a microfluidic chip, is inserted into an apparatus such that it becomes electrically connected to electrical contacts or electrodes. For instance, the electrical contacts or electrodes may be inserted into sample wells in the vessel, at which point an electrical potential is applied to electrically drive fluids and/or electrophorese or purify the sample by introducing an electric field. Often such vessels are disposable, and after carrying out a single assay, are removed, appropriately disposed of and replaced. However, since the electrical contacts have been in contact with the sample, they may be contaminated by substances present in that sample, particularly by macromolecules such as nucleic acids or proteins, or fragments of such molecules, which could interfere with a subsequent use of the apparatus for performing a different assay. This is a particular problem if the macromolecules could participate in the subsequent assay, such as participating in a hybridizing, as this would interfere with that assay and possibly could lead to a false conclusion.

In PCR assays, contamination is a major concern because the assay method is very sensitive. In most situations, those vessels that touch the sample are not reused because of this concern. One method that has been suggested to alleviate the problem presented by potential carry-over contamination is to utilize disposable electrical contacts. U.S. Pat. No. 6,673,533 describes an invention for electrochemiluminescence assays in which electrodes made of composite material are incorporated into a disposable cassette. However, disposing of electrical contacts can substantially increase costs. Alternatively, current microfluidic and microarray devices address the problem of potential carry-over contamination by various methods of cleaning, as described in U.S. Pat. No. 6,787,111. Such techniques include dipping the electrical contacts in cleaning solutions, cleaning with brushes, plasma cleaning and microwaving the electrical contacts. However, such techniques can involve additional consumable materials such as cleaning solutions or expensive or complex equipment being included in the device as well as the additional time required to perform these cleaning steps. The present invention allows the electrical contacts to be reused at relatively low cost and relatively quickly, making the instrumentation simpler and reducing the operating cost and time.

### SUMMARY OF THE INVENTION

In short, the invention comprises a method to substantially eliminate carry-over contamination by electrical contacts in a device, wherein the electrical contacts are in contact with one or more macromolecules during a procedure and wherein an amount of said one or more macromolecules remains on said electrical contacts after contact is completed, the method comprising heating said electrical contacts and/or said amount of one or more macromolecules remaining on said electrical contacts such that said one or more macromolecules remaining thereon are rendered substantially unable to interact with macromolecules of subsequent procedures and are rendered substantially unable to adversely participate in reactions of subsequent procedures in which said electrical contacts later are used.

### DESCRIPTION OF THE DRAWINGS

FIG. 1 is a pair of graphs depicting fluorescence intensity vs. PCR cycle number and a calibration curve showing the log of the DNA starting quantity vs. Ct.

FIG. 2 depicts the concentration of DNA for various experimental test conditions.

FIG. 3 depicts a curve of temperature versus current.

FIG. 4 depicts the concentration of DNA for various test conditions in a second experiment.

### DETAILED DESCRIPTION OF THE INVENTION

The invention comprises a method to substantially eliminate carry-over contamination by electrical contacts in a device, wherein the electrical contacts are in contact with one or more macromolecules during a procedure and wherein an amount of said one or more macromolecules remains on said electrical contacts after contact is completed; the method comprising heating said electrical contacts and/or said amount of one or more macromolecules remaining on said electrical contacts such that said one or more macromolecules remaining thereon are rendered substantially unable to interact with macromolecules of subsequent procedures and are rendered substantially unable to adversely participate in reactions of subsequent procedures in which said electrical contacts later are used.

“Macromolecules”, as is understood by those skilled in the art, refers to polymers of organic compounds found in cells. Carbohydrates, lipids, proteins and nucleic acids are the four major classes of macromolecules and, although the invention as described herein may refer to nucleic acids, or portions thereof, it should be understood that the described method can be used with all polymers of organic compounds found in cells.

The methods of this invention can be used to render nucleic acid contaminants on electrical contacts or electrodes unamplifiable, i.e., being unable to interfere with a subsequent PCR or other assay carried out using the same apparatus, or unable to hybridize such that any such carryover would not interfere with a subsequent hybridization. These methods treat the electrical contacts such that they could be used multiple times for successive assays or other procedures without carrying over contamination from one assay to the next. The primary devices or vessels for which this invention is intended is for use are microfluidic chips. However it is also applicable to other microbiology assay platforms and for other types of assays in addition to PCR. It is suitable, for example, for use with electrophoresis, electroporation, and high-throughput electroporation processes and apparatuses and with vessels used in such processes such as electroporation cuvettes. The methods of this invention can also be used to deactivate or render other types of macromolecules unable to participate in, especially unable to interfere with, subsequent processes or reactions.

Thus, by use of this invention, reusable electrical contacts may be used in the apparatus in question allaying concern that contamination could affect the accuracy of results of subsequent assays or other procedures using the same electrical contacts. In the methods of the invention as applied to PCR assays, for instance, heat is used to render nucleic acid contamination essentially unamplifiable by PCR. In other procedures, heat is applied so as to render contaminant macromolecular substances essentially incapable of interfering with subsequent procedures using the same apparatus, as mentioned above.

The heat required can be generated in a number of ways, as convenient. For example, the heat can be provided by joule heating of the electrodes themselves, by joule heating of a material in contact with the electrodes, by contacting the electrodes with a hot surface, or by any other suitable or convenient means. The term “joule heating” is understood in the art to mean the increase in temperature of a conductor as a result of resistance to an electrical current flowing through it. The overall process may be a PCR assay, or any other type of assay or other process for which the results are dependent on nucleic acid hybridization, or an assay that involves proteins or fragments of nucleic acids or proteins. By “involves” is meant that the macromolecular substance may be introduced into the procedure or process or may be generated during it.

In one embodiment, a disposable microfluidic chip is inserted into a reusable processing instrument that includes electrodes. After an assay or other procedure is carried out using the chip, nucleic acids remain on the electrodes. A low electrical resistance path is then placed between the electrodes and a relatively large electrical current is applied, heating the electrodes and rendering nucleic acids on them unable to be subsequently amplified by PCR. The low resistance path is then removed and a new chip is inserted and the electrodes are then used with the new chip. This process can be repeated a number of times with heating of the electrodes in a similar manner between operations or assays. Alternatively the electrical contacts may be formed into a loop such that current may be applied to a single electrode without the low resistance path. In another embodiment a high electrical resistance path is used between the electrodes, and is heated by joule heating, conducing heat back to the electrodes. Other heating methods and other applications could be employed instead, as described above.

This invention is of particular use in microfluidic or lab-on-a-chip applications in which disposable sample vessels come in repeated contact with nondisposable instrument electrodes.

Another embodiment of the invention relates to the application of the methods to separation of nucleic acids from a crude lysate using an electrical charge. To carry out this type of process it is necessary to have electrical contact between the processing instrumentation and the disposable chip. A proposed method for making electrical contact is through electrically conductive plastic which would be co-molded into the chip; however cost constraints may make that approach unattractive. The use of the methods of this invention allows for the inclusion of reusable electrodes in the apparatus and reduces cost.

### EXAMPLE 1

This example demonstrates that heating an electrode contaminated with nucleic acids renders such contaminants unamplifiable by PCR.

Small lengths of platinum wire were used to simulate electrical contacts in the processing instrument. These wires were dipped into a denatured DNA solution in PCR buffer, allowed to dry, heated, and then dipped into a qPCR reaction solution. The amount of amplifiable DNA transferred from the wire to the reaction solution was then quantified with quantitative PCR (qPCR).

The substrate was 0.016″ diameter platinum wire cut to 10-mm length. An apparatus was arranged such that 5 mm of the wire would be submerged into a microplate vessel filled with 50 μl in each reaction well during the dipping steps; leaving an additional 5 mm of dry length for handling and heating. The first dip was for 1 minute in 50 μl of 10⁷ molecules/μl denatured bacteriophage lambda DNA to a depth of 5 mm. The wires were removed from the solution and left to air dry for 1 hour.

The wires were then heated for 1 minute. Heating was performed by contacting the wire, on its undipped end, with a soldering iron. The temperature of the wire was controlled with the temperature control on the soldering iron power supply. The soldering iron was set to the following temperatures for the heating step: off, 250° C., 350° C., and 480° C. The temperature of the dipped region of the wire is expected to be somewhat less than the temperature of the soldering iron due to heat loss into the air. Thermal models predict that the temperature of the dipped region of the wire to be 224° C. for the 250° C. set point on the soldering iron, 310° C. for the 350° C. set point, and 420° C. for the 480° C. set point. Settling time for all temperatures mentioned is less than 4 seconds.

The wires were then each dipped into a well containing 50 μl of iQ SYBR Green Supermix® qPCR reaction mixture (Bio-Rad Laboratories, #170-8880) with lambda-specific PCR primers (LAM65) to a depth of 5 mm for a duration of 1 minute. The amount of amplifiable DNA in each reaction mix was then quantified by qPCR, using a 40-cycle two-step protocol (each cycle containing 92° C. for 5 seconds, 68° C. for 30 seconds, and a plate read) followed by a melting curve to verify the products of the PCR reactions. Wire transfer tests were run in triplicate with duplicate lambda DNA quantitation standards at 0, 10¹, 10², 10³, & 10⁴ molecules/μl. The wire sample transfer (i.e., carry-over contamination) was quantified by reference to the DNA quantitation standards data.

With no heat applied to the wire, significant sample transfer was observed, >2000 molecules/μl or >10⁴ molecules/r×n. On the samples heated to 224° C., that number reduced by almost a factor of 10. On the samples heated to 310° C. or higher, the amount of transferred amplifiable DNA was indistinguishable from the negative controls.

Results are shown in the Figures.

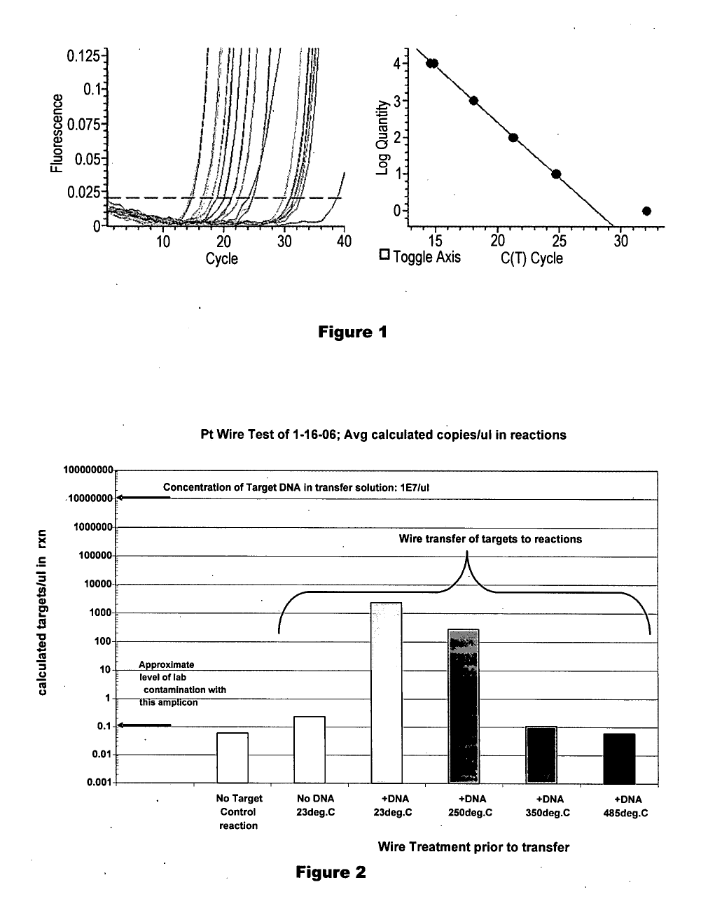

In FIG. 1, the left-hand graph depicts fluorescence intensity vs. PCR cycle number for the unknowns (solutions that had the electrodes dipped in them after the electrodes were heat processed), DNA standards, and controls. The right-hand graph is a calibration curve made from the DNA standards. It shows the log of the DNA starting quantity vs. Ct. The Ct is defined as the cycle at which a reaction signal reaches a defined signal threshold above the system background level. As is well known in the field, the Ct of a reaction can be used as an accurate estimator of the initial number of targets in a PCR reaction when referenced to a set of Cts of known initial target numbers, i.e., a calibration curve. Applying the calibration curve from the right graph, the Ct numbers of the unknowns of the left graph can be converted to DNA starting quantities.

FIG. 2 depicts the concentration of DNA, as determined from the FIG. 1 graphs, for the various experimental test conditions performed. Note that in the 350° C.- and 485° C.-heat-treated conditions, the amount of amplifiable DNA that was carried over is indistinguishable from the negative controls. However, in the lower temperature heat treatment conditions, the amount of amplifiable DNA is much greater than the negative controls.

The experimental data confirm that it is feasible to reduce the amount of carry-over contamination by treating metal electrical contacts using heat. It also indicates, on the other hand, that contamination from electrical contacts in direct contact with the sample solution may be a serious issue if no measures are taken to treat the contacts between runs. However, it is possible to produce the amount of heat necessary to render DNA unamplifiable using joule heating of the contacts, for example, power calculations of the requirement for joule heating of electrodes of this configuration yield 5A at 20 mV.

### EXAMPLE 2

This example demonstrates that joule heating of an electrode contaminated with nucleic acids renders such contaminants unamplifiable by PCR. As in Example 1, small lengths of platinum wire were used to simulate electrical contacts in the processing instrument. However unlike that example, where straight pieces of wire were used, in this experiment the wire was bent into a hairpin shape that allowed the center portion to be dipped into the solutions and the ends to be used to contact a constant current electrical power source.

These wires were dipped into a denatured DNA solution in PCR buffer, allowed to dry, heated, and then dipped into a qPCR reaction solution. The amount of amplifiable DNA transferred from the wire was then quantified with qPCR as above.

The substrate was 0.016″ diameter platinum wire cut to 36-mm length and bent into a hairpin shape. The shape is such that the wires conveniently fit into the well of a 96 well microplate. The wires were dipped for 1 minute in 50 μl of 10⁷ molecules/μl denatured lambda DNA. This volume immersed about 4 mm of the loop (total about 8 mm of wire immersed). The wires were removed from the solution and left to air dry for approximately 1 hour.

The wires were then heated for 1 minute. The heating was performed by attaching alligator clips to the ends of each wire and applying a constant current through the wire that heated the wire by ajoule heating mechanism. Preliminary work identified the currents required to raise the wire to defined temperatures for the experiment (see next section). The targeted temperatures were 23° C. (no additional heating), 149° C., 305° C., 344° C., and 444° C.

The wires were then each dipped into a well containing 50 μl of iQ SYBR Green Supermix® qPCR reaction mixture (Bio-Rad Laboratories, #170-8880) with lambda-specific PCR primers (LAM65) for the duration of 1 minute. The wires were removed and the amount of amplifiable DNA transferred into each reaction mix (the “carryover”) was then quantified by qPCR, using a 40 cycle two-step protocol (each cycle containing 92° C. for 5 seconds, 68° C. for 30 seconds, and a plate read) followed by a melting curve. Wire transfer tests were run in duplicate with duplicate lambda DNA quantitation standards at 0, 10¹, 10², 10³, 10⁴ and 10⁵ molecules/μl.

Data is presented in FIG. 4 using the same format as in Example 1. The 444° C. data is based on one Ct, the other one being considered as an “outlier”. All others are based on the average of 2 Cts.

As in the previous experiments, with no heat applied to the wire, significant sample transfer was observed of 60 amplifiable molecules/μl. In the samples heated to 149° C. (3.5 amps), the carryover was reduced by more than 10 fold. On the samples heated to 305° C. (5.0 amps) or higher, the amount of transferred amplifiable DNA was reduced again by greater than 10 fold and the level was indistinguishable from that of the negative controls.

### Determination of the Joule Heating Current Values for Example 2

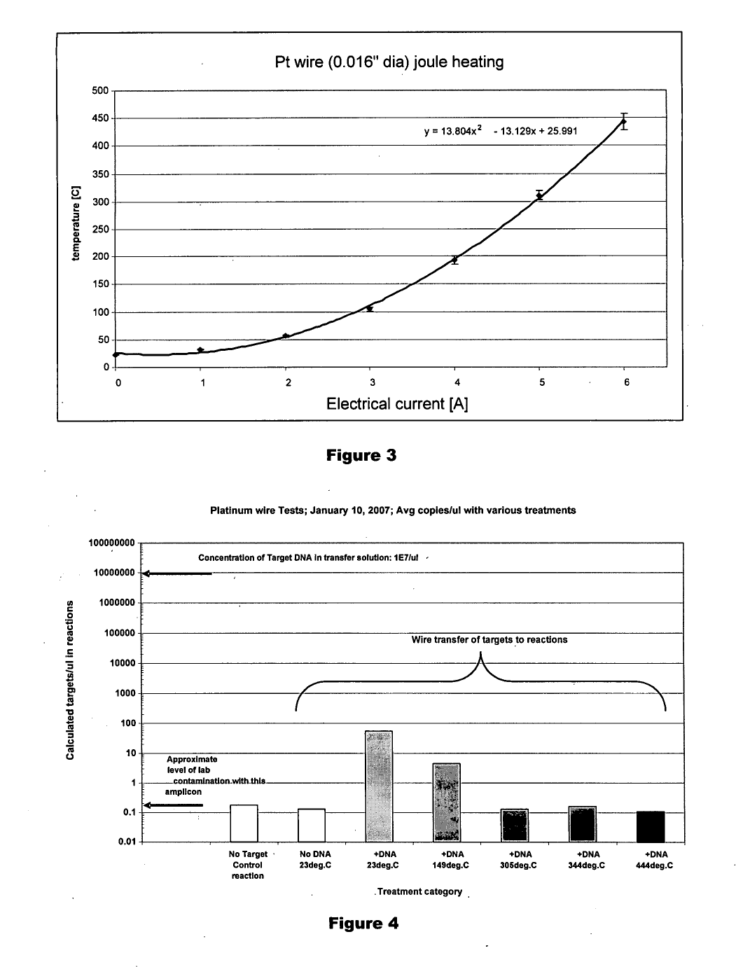

The wire temperature as a function of electrical current is dependent on the material, wire diameter, ambient temperature, and heat-loss conditions (i.e., air density, humidity, air convection, etc.). An additional experiment was performed to characterize this function for these conditions. Electrical current was applied through a wire identical to that used for Example 2. A small thermocouple (Omega 5CC-TT-K-40-36) was placed in contact with the wire, with a small drop of thermal grease acting as an interface. A curve of temperature versus current was generated (FIG. 3) which was used to define the current values for the experiment in Example 2.

What is claimed is:

1. A method to substantially eliminate carry-over contamination by electrical contacts in a device, wherein the electrical contacts are in contact with one or more macromolecules during a procedure and wherein an amount of said one or more macromolecules remains on said electrical contacts after contact is completed,
the method comprising heating said electrical contacts and/or said amount of one or more macromolecules remaining on said electrical contacts such that said one or more macromolecules remaining thereon are rendered substantially unable to interact with macromolecules of subsequent procedures and are rendered substantially unable to adversely participate in reactions of subsequent procedures in which said electrical contacts later are used.

2. A method according to claim 1 in which the macromolecules are selected from proteins, nucleic acids and fragments thereof.

3. A method according to claim 1 in which the procedure is an assay for which results are dependent on nucleic acid hybridization.

4. A method according to claim 1 in which the procedure is a polymerase chain reaction process.

5. A method according to claim 1 in which the device is a microfluidic device.

6. A method according to claim 1 in which the device is a microfluidic chip.

7. A method according to claim 1 wherein said heating comprises joule heating.

8. A method according to claim 1 wherein said heating comprises joule heating of said electrical contacts.

9. A method according to claim 1 wherein said heating comprises heating of a material in contact with said electrical contacts.

10. A method of rendering nucleic acids substantially unamplifiable comprising subjecting said nucleic acids to heat.
